(19) United States
(12) Patent Application Publication
(10) Pub. No.: US 2026/0287450 A1
(43) Pub. Date: Sep. 24, 2026

(54) DETERMINATION SYSTEM AND DETERMINATION METHOD

(71) Applicants: Kabushiki Kaisha Toshiba, Kawasaki-shi (JP); Toshiba Electronic Devices & Storage Corporation, Kawasaki-shi (JP)

(72) Inventors: Masatoshi TANABE, Yokohama Kanagawa (JP); Yasunari UKITA, Kamakura Kanagawa (JP); Akira TOJO, Naka Kanagawa (JP)

(21) Appl. No.: 19/451,987

(22) Filed: Jan. 16, 2026

(30) Foreign Application Priority Data
Mar. 21, 2025 (JP) 2025-046744

(51) Int. Cl. G01L 5/00

(52) U.S. Cl. CPC G01L 5/0076; G01L 5/0038

(57) ABSTRACT

According to one embodiment, a determination system includes a data acquisition part and a determination part. The data acquisition part is configured to acquire position data and load data from a press machine, the position data being related to a position of a die assembly, the load data being related to a load applied to the die assembly. The press machine is configured to move the die assembly including a working part to work a workpiece by pressing the working part onto the workpiece. The determination part is configured to determine a state of the working part based on the acquired position data and the acquired load data.

### CROSS-REFERENCE TO RELATED APPLICATIONS

This application is based upon and claims the benefit of priority from Japanese Patent Application No.2025-046744, filed on Mar 21, 2025; the entire contents of which are incorporated herein by reference.

### FIELD

Embodiments of the invention relate generally to a determination system and a determination method.

### BACKGROUND

In a press machine that works a workpiece by moving a die assembly, pressing defects of the workpiece occur due to wear of punches or dies. Patent Literature 1 discusses a press machine in which a load applied to a working part is detected, and a wear amount of a punch and a die are calculated by analyzing a load waveform generated based on the temporal change of the load. There is a need for technology that can more easily determine the state of a working part such as a punch, a die, or the like in a press machine.

### BRIEF DESCRIPTION OF THE DRAWINGS

FIG. 1 is a schematic view showing a press control system according to an embodiment;

FIGS. 2A and 2B are schematic views showing an operation of a press machine;

FIG. 3 is a graph for describing functions of a determination part;

FIG. 4 is a graph for describing the functions of the determination part;

FIG. 5 is a flowchart showing an example of processing of the press control system;

FIG. 6 is a graph for describing processing of a correction part;

FIGS. 7A and 7B are enlarged views of region R3 and region R4 of FIG. 6;

FIG. 8 is a flowchart showing an example of processing of the press control system; and

FIG. 9 is a block diagram showing a hardware configuration of a determination system.

### DETAILED DESCRIPTION

According to one embodiment, a determination system includes a data acquisition part and a determination part. The data acquisition part is configured to acquire position data and load data from a press machine, the position data being related to a position of a die assembly, the load data being related to a load applied to the die assembly. The press machine is configured to move the die assembly including a working part to work a workpiece by pressing the working part onto the workpiece. The determination part is configured to determine a state of the working part based on the acquired position data and the acquired load data.

### 1. Embodiments

Embodiments of the disclosure will now be described with reference to the drawings. In the specification and drawings, components similar to those already described are marked with the same reference numerals; and a detailed description is not repeated.

### 1.1 Configuration of press control system 1

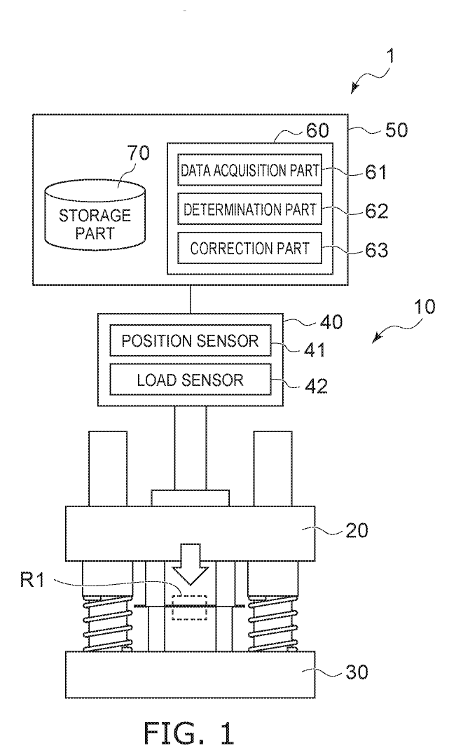

A configuration of a press control system 1 will now be described with reference to FIG. 1.

FIG. 1 is a schematic view showing the press control system 1 according to an embodiment. As shown in FIG. 1, the press control system 1 includes a press machine 10 and a determination system 50. The press control system 1 controls the press machine 10 that works a workpiece by moving a die assembly. The press control system 1 also determines the state of a working part of the press machine 10 by using data obtained from the press machine 10.

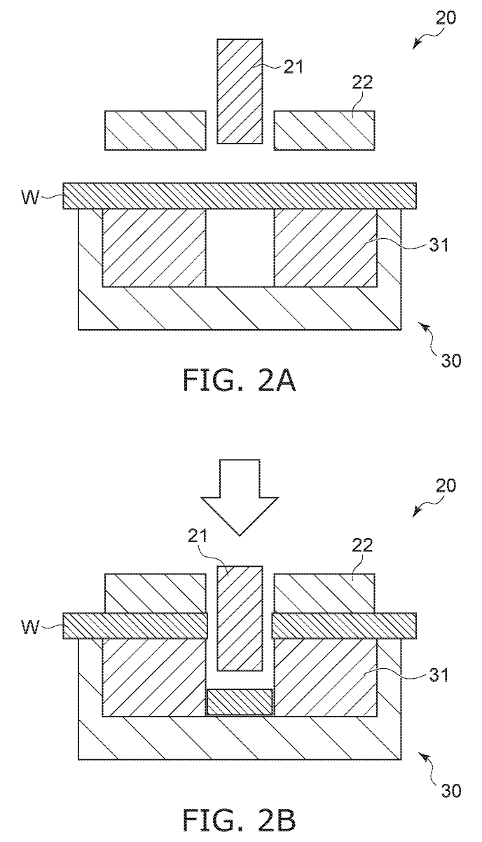

FIGS. 2A and 2B are schematic views showing an operation of the press machine. FIGS. 2A and 2B are enlarged drawings of region R1 of FIG. 1.

As shown in FIG. 1, the press machine 10 includes an upper die 20 and a lower die 30 as a die assembly, and a servo controller 40. As shown in FIG. 2A, the upper die 20 includes a punch 21 and a stripper 22. The stripper 22 is arranged around the punch 21. The punch 21 and the stripper 22 are vertically movable. Furthermore, the punch 21 is vertically movable relative to the stripper 22. The lower die 30 includes a die 31. The die 31 has a recess at a position arranged in the vertical direction with the punch 21. The punch 21 is an example of a working part. The die 31 is another example of a working part.

In the pressing, a workpiece W is placed between the upper die 20 and the lower die 30 as shown in FIG. 2A. Then, at least one of the upper die 20 or the lower die 30 moves toward the other. In the illustrated example, the upper die 20 moves in the downward direction (i.e., the arrow direction of FIG. 2B). The stripper 22 contacts the workpiece W; and the workpiece W is sandwiched and fixed between the die 31 and the stripper 22.

Then, the punch 21 moves toward the recess of the die 31 and contacts a portion of the workpiece W. Subsequently, the punch 21 moves further in the downward direction relative to the stripper 22. As a result, as shown in FIG. 2B, the portion of the workpiece W is worked by being pressed.

"Working" may be the cutting (punching) shown in FIGS. 2A and 2B, or may be bending, forming, piercing, etc. "Bending" is bending of a plate to a specific angle. "Forming" is working that transforms a material into a prescribed target shape. "Piercing" is working that makes an opening in a material.

The servo controller 40 controls movement in the vertical direction of at least one of the upper die 20 or the lower die 30. More specifically, the press machine 10 includes an actuator for moving at least one of the upper die 20 or the lower die 30. The servo controller 40 controls the movement in the vertical direction of at least one of the upper die 20 or the lower die 30 by controlling the actuator. In the example shown in FIG. 1, the movement in the vertical direction of the upper die 20 is controlled by the servo controller 40.

The servo controller 40 also includes a position sensor 41 and a load sensor 42. The position sensor 41 detects the position of the movable die assembly and generates position data indicating the position. The load sensor 42 detects the load applied to the working part and generates load data indicating the load. In the illustrated example, the position sensor 41 generates position data that indicates the position of the upper die 20 (the punch 21). The load sensor 42 generates load data that indicates the load applied to the upper die 20.

The determination system 50 processes the data acquired from the servo controller 40. The determination system 50 includes an information processing part 60 and a storage part 70. A hardware configuration of the determination system 50 is described below.

The information processing part 60 includes a data acquisition part 61, a determination part 62, and a correction part 63. The data acquisition part 61 acquires the position data and the load data from the servo controller 40.

Based on the position data and the load data acquired by the data acquisition part 61, the determination part 62 determines the state of the working part (the punch 21 or the die 31) of the press machine 10. The correction part 63 corrects the data used in the determination by the determination part 62. Details of the processing of the determination part 62 and the correction part 63 are described below.

The storage part 70 stores data necessary for the processing of the determination system 50. As an example, the storage part 70 stores a prescribed first threshold related to the load, and reference data indicating the relationship between the position and the load of the upper die 20. Details of the first threshold and the reference data are described below.

### 1.2 Function of determination part 62

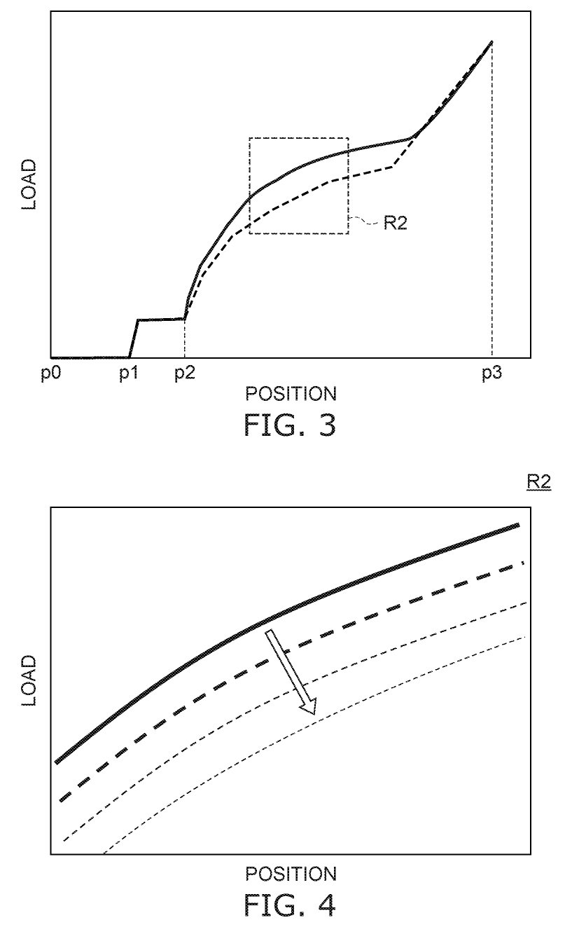

Functions of the determination part 62 will now be described with reference to FIGS. 3 and 4.

FIGS. 3 and 4 are graphs for describing functions of the determination part 62. Specifically, FIGS. 3 and 4 are graphs showing the relationship between the position of the upper die 20 and the load applied to the upper die 20 (hereinbelow, referred to as the position-load relationship). FIG. 4 is an enlarged view of region R2 of FIG. 3. In FIGS. 3 and 4, the horizontal axis is the vertical-direction position of the upper die 20. The vertical axis is the load applied to the upper die 20.

In the example shown in FIG. 3, the upper die 20 is lowered from an origin position p0, and the stripper 22 of the upper die 20 contacts the workpiece W at a position p1. The upper die 20 is controlled to move further in the downward direction, and presses the workpiece W. The reaction force from the workpiece W is detected as the load. In this state, the punch 21 moves relative to the stripper 22; and the punch 21 contacts the workpiece W when lowered to a position p2. The punch 21 moves further in the downward direction, presses the workpiece W, and works the workpiece W. The detected load also increases as the workpiece W is pressed. For example, the upper die 20 moves downward to a limit position p3 at the limit of the movement of the upper die 20.

FIGS. 3 and 4 show changes of the position-load relationship according to the state of the punch 21. In FIG. 3, the solid line illustrates the position-load relationship when the punch 21 is in a good state. The broken line illustrates the position-load relationship when the punch 21 is not in a good state. For example, as the working by the press machine 10 is repeated, the position-load relationship changes as in the arrow shown in FIG. 4.

The change of the position-load relationship is caused by wear of the working part. For example, it can be seen from FIG. 4 that even when the upper die 20 (the punch 21) is at the same position, the magnitude of the detected load decreases as the wear of the punch 21 increases. In other words, even for the same magnitude of the load, the upper die 20 (the punch 21) moves more easily with respect to the workpiece W as the wear of the punch 21 increases. This is because as the wear of the punch 21 increases, the tip of the punch 21 becomes sharper and is subjected to less resistance when pressing the workpiece W. Similarly, wear of the die 31 in the press machine 10 also may occur. As the die 31 wears, the resistance when pressing the workpiece W when the workpiece W is sandwiched between the punch 21 and the die 31 decreases, and so the detected load decreases.

The determination part 62 determines the state of the working part by comparing the load when the upper die 20 (the punch 21) is at a prescribed position to the first threshold. As an example, when the load of the upper die 20 is not less than the first threshold when the upper die 20 is at the prescribed position, the determination part 62 determines that the state of the working part is a first state. When the load is less than the first threshold, the determination part 62 determines that the state of the working part is a second state.

The first threshold is appropriately set according to the state of the working part to be determined, the required quality of the working, etc. As an example, the first state represents a state in which the working part is in a good state with little wear of the working part. The second state represents a state in which the working part is worn and the working part is not in a good state. In the second state, replacement of the working part is recommended.

The determination part 62 may output an alert according to the determination result of the state. The determination part 62 outputs a first alert when the state of the working part is determined to be the second state. The first alert indicates that the working part is worn. The first alert may request replacement of the working part. For example, the first alert is output as a message on a display device such as a monitor, etc. A notification may be transmitted to a preregistered terminal device as the first alert.

Multiple thresholds may be set for the load. For example, prescribed first and second thresholds are set. The second threshold is less than the first threshold. The determination part 62 determines that the state of the working part is the second state when the upper die 20 is at the prescribed position and the load applied to the upper die 20 is less than the first threshold and not less than the second threshold. When the load is less than the second threshold, the determination part 62 determines that the state of the working part is the third state.

Excessive wear of the working part causes defects to occur in the worked workpiece W. For example, the second state represents a state in which the working part is worn, but is not worn to the extent that defects occur in the workpiece W. The third state represents a state in which the working part is worn and defects may occur in the workpiece W.

When the state of the working part is determined to be the third state, the determination part 62 outputs a second alert that is different from the first alert. For example, when the state of the working part is the third state, it is considered that a defect has occurred in the workpiece being worked. The second alert indicates that a defect of the workpiece W has occurred. The second alert may be output to the display device, or may be transmitted to a preregistered terminal device.

As another example, a single threshold (the first threshold) may be set to be lower. For example, the first threshold may be set to be about equal to the second threshold described above. In such a case, the first state indicates that the wear of the working part is in a state in which defects have not occurred in the workpiece W. The second state indicates that the wear of the working part is in a state in which defects occur in the workpiece W.

The correction part 63 corrects the data used in the state determination of the working part. The function of the correction part 63 may be omitted. However, to increase the determination accuracy of the state of the working part, it is favorable for the determination system 50 to include the correction part 63.

Specifically, the position sensor 41 detects the position of the upper die 20 (the punch 21) referenced to a prescribed origin position. Fluctuation of the origin position may occur regardless of the state of the working part. For example, component members of the die assembly and the servo controller deform (undergo thermal expansion and heat shrinkage) according to the temperature. Due to the deformation of the die assembly, the origin position when working the workpiece W may fluctuate from the preset origin position. The fluctuation of the origin position affects the determination result. The correction part 63 corrects the position at which the load to be compared with the first threshold is extracted according to the fluctuation of the origin position.

### 1.2 Flow of processing of press control system

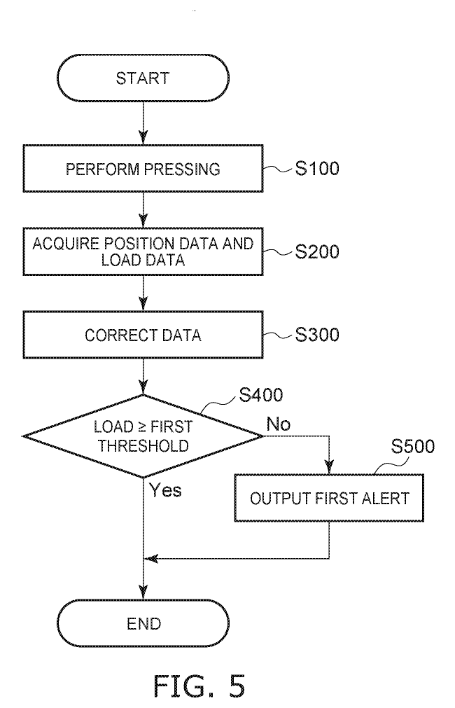

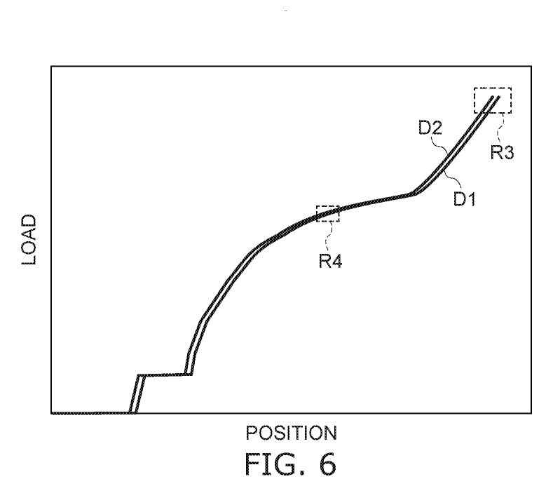

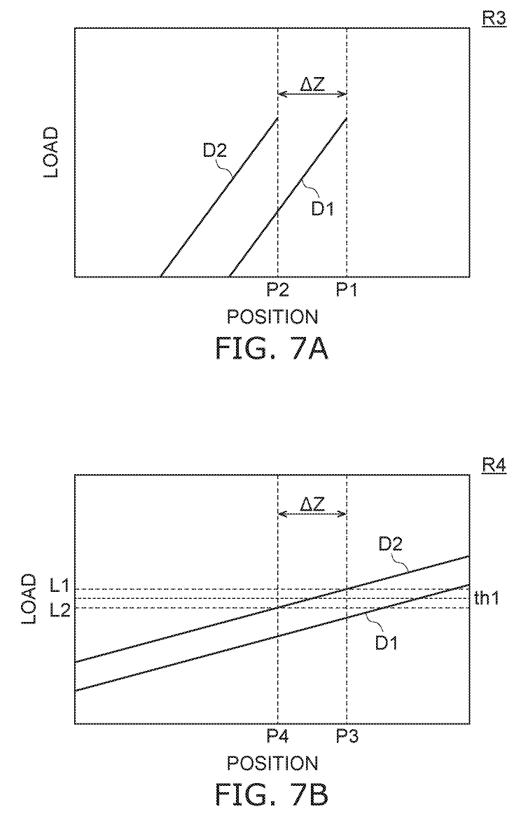

The flow of processing of the press control system 1 will now be described with reference to FIGS. 5 to 7B. FIG. 5 is a flowchart showing an example of the processing of the press control system 1. FIG. 6 is a graph for describing the processing of the correction part. FIGS. 7A and 7B are enlarged views of region R3 and region R4 of FIG. 6.

In step S100, the servo controller 40 controls the movement of the upper die 20 to perform pressing. In the pressing, the position sensor 41 that is included in the servo controller 40 generates the position data of the upper die 20 (the punch 21). Also, the load sensor 42 that is included in the servo controller 40 generates the load data applied to the upper die 20.

In step S200, the data acquisition part 61 acquires the position data generated by the position sensor 41 and the load data generated by the load sensor 42.

In step S300, the correction part 63 refers to the reference data stored by the storage part 70 and corrects the first threshold or the prescribed position.

FIG. 6 shows reference data D1 and actual data D2 acquired by the data acquisition part 61 during the pressing. In FIGS. 6, 7A, and 7B, the horizontal axis is the vertical-direction position of the upper die 20. The vertical axis is the load applied to the upper die 20. Herein, the vertical-direction position of the upper die 20 is referred to as the "Z-position".

Specifically, first, the correction part 63 acquires the Z-position (a first position) from the reference data D1 when the upper die 20 is in the prescribed state. The correction part 63 also acquires the Z-position (a second position) from the actual data D2 when the upper die 20 is in the prescribed state. A state that has an origin position that does not fluctuate is used as the prescribed state. For example, the state in which the upper die 20 has moved to a limit position at the limit of the movement of the upper die 20 in the upward or downward direction is set as the prescribed state.

FIG. 7A shows data when the upper die 20 has moved to the limit position at the limit of the movement in the downward direction. Herein, the limit position at the limit of the movement in the downward direction is referred to as bottom dead center. The correction part 63 acquires a Z-position P1 of the punch 21 at bottom dead center from the reference data D1, and acquires a Z-position P2 of the punch 21 at bottom dead center from the actual data D2. As shown in FIG. 7A, due to fluctuation of the origin position, a difference ΔZ occurs between the Z-position P1 and the Z-position P2. The correction part 63 calculates the difference ΔZ.

In the determination, the load when the upper die 20 (the punch 21) is at the prescribed position is extracted from the load data. For example, as shown in FIG. 7B, a load L1 at a prescribed position P3 is extracted from the actual data D2. When a correction is not performed, the determination part 62 determines the state of the working part by comparing the extracted load L1 to a preset first threshold th1.

When a correction is performed, the correction part 63 corrects the position P3 at which the load is extracted according to the difference ΔZ. Specifically, the correction part 63 calculates a position P4 by subtracting the difference ΔZ from the position P3. As a result, the position at which the load is extracted is corrected to the position P4.

In step S400, the determination part 62 extracts a load L2 at the position P4 after correcting from the actual data D2. The determination part 62 compares the load L2 to the first threshold th1.

When the load is not less than the first threshold (Yes in step S400), the determination part 62 determines that the state of the working part is the first state, and ends the processing. On the other hand, when the load is less than the first threshold (No in step S400), the determination part 62 determines that the state of the working part is the second state, and performs step S500. In step S500, the determination part 62 outputs the first alert.

As another example, the correction part 63 may correct the first threshold th1 according to the difference ΔZ in step S300. For example, the relationship between the difference ΔZ and the correction amount of the threshold is preregistered in the storage part 70. When the difference ΔZ has been calculated, the correction part 63 acquires a correction amount corresponding to the difference ΔZ. The correction part 63 uses the correction amount to correct the first threshold th1. In step S400, the determination part 62 compares the load L1 at the position P3 to the first threshold th1 after correcting.

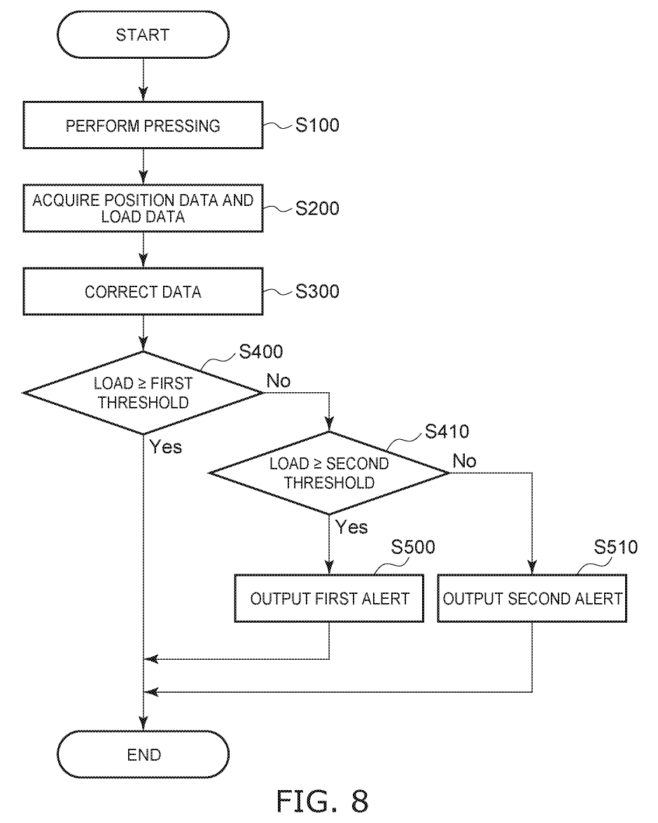

FIG. 8 is a flowchart showing another example of processing of the press control system 1.

The processing shown in FIG. 8 may be performed instead of the processing shown in FIG. 5. In the processing shown in FIG. 8, steps S100 to S400 are performed similarly to the processing shown in FIG. 5. When the load is less than the first threshold in step S400, the determination part 62 compares the load to the second threshold in step S410. The second threshold is a value that is less than the first threshold.

When the load is not less than the second threshold (Yes in step S410), the determination part 62 determines that the state of the working part is the second state, and outputs the first alert in step S500. When the load is less than the second threshold (No in step S410), the determination part 62 determines that the state of the working part is the third state, and outputs the second alert in step S510. According to the processing shown in FIG. 8, the state of the working part can be more specifically determined.

### 1.3 Hardware configuration of determination system 50

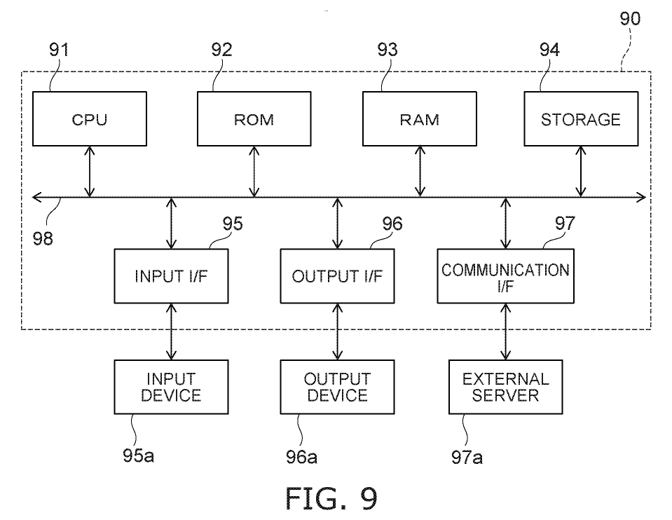

FIG. 9 is a block diagram showing a hardware configuration of a determination system.

The hardware configuration of the determination system 50 will now be described with reference to FIG. 9. As an example, the determination system 50 is realized by a computer 90 shown in FIG. 9. The computer 90 includes a CPU 91, ROM 92, RAM 93, storage 94, an input interface 95, an output interface 96, and a communication interface 97.

The CPU 91 functions as a processor that performs processing of the information processing part 60. Specifically, the CPU 91 uses the RAM 93 as work memory to execute the programs stored in at least one of the ROM 92 or the storage 94. When executing the programs, the CPU 91 executes various processing by controlling configurations via a system bus 98.

The ROM 92 stores programs controlling operations of the computer 90 as the storage part 70. The ROM 92 stores programs necessary for causing the computer 90 to realize the processing described above. The RAM 93 functions as a memory region into which the programs stored in the ROM 92 are loaded.

The storage 94 stores data necessary for executing the programs and/or data obtained by executing the programs as the storage part 70. The storage 94 includes at least one selected from a HDD (Hard Disk Drive) and a SSD (Solid State Drive). The storage 94 may be implemented as an external storage medium such as an SD card, USB (Universal Serial Bus) memory, etc.

The input interface (I/F) 95 can connect the computer 90 and an input device 95a. The input interface 95 is, for example, a serial bus interface such as USB, etc. The CPU 91 can read various data from the input device 95a via the input interface 95.

The output interface (I/F) 96 can connect the computer 90 and an output device 96a. The output interface 96 is, for example, an image output interface such as DVI (Digital Visual Interface), HDMI (High-Definition Multimedia Interface/registered trademark), etc. The CPU 91 can transmit data to the output device 96a via the output interface 96, and can cause the output device 96a to output the data.

The input device 95a is an example of an input part, and may include at least one selected from a microphone (audio input) and a touchpad. The output device 96a is an example of an output part, and may include a display. The output device 96a also may include a speaker (an audio output). The computer 90 may include a device such as a touch panel that functions as both the input device 95a and the output device 96a.

The communication interface (I/F) 97 can connect the computer 90 and an external server 97a that is outside the computer 90. The communication interface 97 is, for example, a network card such as a LAN card, etc. The CPU 91 can read various data from the external server 97a via the communication interface 97.

The processing that is performed by the determination system 50 may be realized by one computer 90, or may be realized by collaboration of multiple computers 90. For example, the processing of the data acquisition part 61, the determination part 62, and the correction part 63 may be performed by separate computers 90.

For example, the storage 94 may be used as the storage part 70. Or, an external storage device connected to the computer 90 via the communication I/F 97 may be used as the storage part 70.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a processor to execute the instructions recited in the program based on the program. In the computer, the acquisition (or the reading) of the program may be performed via a network.

Advantages of embodiments will now be described.

When the press machine 10 performs pressing, the relationship between the position and the load of the die assembly may fluctuate according to the degree of the wear of the working part. Based on this knowledge, in the determination system 50 according to the embodiment, the data acquisition part 61 acquires the position data and the load data from the press machine 10. Then, based on the position data and the load data, the determination part 62 determines the state of the working part. According to the embodiment, the state of the working part can be determined more easily without using data such as the temporal change of the load, etc.

The load that is applied to the die assembly when the die assembly is at a prescribed position can be used for the determination. For example, the determination part 62 extracts the load when the die assembly is at the prescribed position, and compares the load to the prescribed first threshold.

When the load is compared to the threshold, it is favorable to correct the prescribed position at which the load is extracted. Or, the first threshold that is compared to the load may be corrected. As described above, when the position data is used, a preset origin position may fluctuate due to deformation of the die assembly. There is a possibility that the fluctuation of the origin position may affect the determination result. By correcting the prescribed position or the first threshold, the effects of the fluctuation of the origin position on the determination result can be reduced, and the accuracy of the determination can be increased.

For example, according to the actual data D2 shown in FIG. 7B, the load L1 at the position P3 before correcting is not less than the first threshold th1. Therefore, the state of the working part is determined to be the first state. On the other hand, the load L2 at the position P4 after correcting is less than the first threshold th1. Therefore, the state of the working part is determined to be the second state. The state of the working part can be determined more accurately by correcting.

### 2. Other embodiments

Although the press control system 1 according to an embodiment is described above, applications of the technical idea of the disclosure are not limited to the embodiments above. For example, according to the embodiments above, the correction part 63 calculates the difference ΔZ by using the position when the upper die 20 has moved to bottom dead center; however, embodiments of the invention are not limited to this example. In other words, a difference between the position data of the upper die 20 and the reference position data may be calculated when the upper die 20 has moved to a point other than bottom dead center. For example, the difference ΔZ may be calculated using the position when the upper die 20 has moved to the limit position at the limit of the movement of the upper die 20 in the upward direction.

A method is described in embodiments above in which the state of the working part is determined when the press machine 10 performs piercing. The embodiments are not limited to the example, and are applicable even when the press machine 10 performs bending or forming. In such a case as well, the load that is applied to the die assembly when the die assembly is at a prescribed position is acquired, and the load is compared to a threshold.

According to the embodiments above, press machine 10 includes the upper die 20 and the lower die 30; and the upper die 20 moves in the vertical direction. Embodiments are applicable to the press machine 10 in which the lower die 30 moves in the vertical direction, and are applicable to the press machine 10 in which the die assembly moves in a horizontal direction. The movement of the die assembly may be in any direction.

The disclosure may include the following features.

### Feature 1

A determination system, including:

a data acquisition part configured to acquire position data and load data from a press machine configured to move a die assembly including a working part to work a workpiece by pressing the working part onto the workpiece, the position data being related to a position of the die assembly, the load data being related to a load applied to the die assembly; and

a determination part configured to determine a state of the working part based on the acquired position data and the acquired load data.

### Feature 2

The determination system according to feature 1, in which

the determination part is configured to:

extract a load applied to the die assembly when the die assembly is at a prescribed position based on the position data and the load data; and

determine the state of the working part by comparing the extracted load to a first threshold, the first threshold being prescribed.

### Feature 3

The determination system according to feature 2, further including:

a correction part configured to

refer to reference data indicating a relationship between the load applied to the die assembly and the position of the die assembly, the relationship being preregistered, and

correct the first threshold or the prescribed position by using the reference data.

### Feature 4

The determination system according to feature 3, in which

the correction part is configured to:

extract a first position when the die assembly is in a prescribed state based on the reference data;

extract a second position when the die assembly is in the prescribed state based on the position data; and

correct the first threshold or the prescribed position by using a difference between the first position and the second position.

### Feature 5

The determination system according to any one of features 2 to 4, in which

the determination part is configured to:

determine that the working part is in a first state when the extracted load is not less than the first threshold; and

determine that the working part is in a second state and output a first alert when the extracted load is less than the first threshold.

### Feature 6

The determination system according to feature 5, in which

the determination part is configured to:

determine that the working part is in a third state and output a second alert when the extracted load is less than a second threshold, the second threshold being less than the first threshold, the second alert being different from the first alert.

### Feature 7

A determination method, including causing a computer to:

acquire position data and load data from a press machine configured to move a die assembly including a working part to work a workpiece by pressing the working part onto the workpiece, the position data being related to a position of the die assembly, the load data being related to a load applied to the die assembly; and

determine a state of the working part based on the acquired position data and the acquired load data.

### Feature 8

The determination method according to feature 7, in which

the computer is caused to:

extract a load applied to the die assembly when the die assembly is at a prescribed position based on the position data and the load data; and

determine the state of the working part by comparing the extracted load to a first threshold, the first threshold being prescribed.

### Feature 9

The determination method according to feature 8, further including causing the computer to:

refer to reference data indicating a relationship between the load applied to the die assembly and the position of the die assembly, the relationship being preregistered; and

correct the first threshold or the prescribed position by using the reference data.

### Feature 10

The determination method according to feature 9, in which

the computer is caused to:

extract a first position when the die assembly is in a prescribed state based on the reference data;

extract a second position when the die assembly is in the prescribed state based on the position data; and

correct the first threshold or the prescribed position by using a difference between the first position and the second position.

### Feature 11

The determination method according to any one of features 8 to 10, in which

the computer is caused to:

determine that the working part is in a first state when the extracted load is not less than the first threshold; and

determine that the working part is in a second state and output a first alert when the extracted load is less than the first threshold.

### Feature 12

The determination method according to feature 11, in which

the computer is configured to determine that the working part is in a third state and output a second alert when the extracted load is less than a second threshold, the second threshold being less than the first threshold, the second alert being different from the first alert.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A determination system, comprising:
a data acquisition part configured to acquire position data and load data from a press machine configured to move a die assembly including a working part to work a workpiece by pressing the working part onto the workpiece, the position data being related to a position of the die assembly, the load data being related to a load applied to the die assembly; and
a determination part configured to determine a state of the working part based on the acquired position data and the acquired load data.

2. The determination system according to claim 1, wherein
the determination part is configured to:
extract a load applied to the die assembly when the die assembly is at a prescribed position based on the position data and the load data; and
determine the state of the working part by comparing the extracted load to a first threshold, the first threshold being prescribed.

3. The determination system according to claim 2, further comprising:
a correction part configured to
refer to reference data indicating a relationship between the load applied to the die assembly and the position of the die assembly, the relationship being preregistered, and
correct the first threshold or the prescribed position by using the reference data.

4. The determination system according to claim 3, wherein
the correction part is configured to:
extract a first position when the die assembly is in a prescribed state based on the reference data;
extract a second position when the die assembly is in the prescribed state based on the position data; and
correct the first threshold or the prescribed position by using a difference between the first position and the second position.

5. The determination system according to claim 2, wherein
the determination part is configured to:
determine that the working part is in a first state when the extracted load is not less than the first threshold; and
determine that the working part is in a second state and output a first alert when the extracted load is less than the first threshold.

6. The determination system according to claim 5, wherein
the determination part is configured to:
determine that the working part is in a third state and output a second alert when the extracted load is less than a second threshold, the second threshold being less than the first threshold, the second alert being different from the first alert.

7. A determination method, comprising causing a computer to:
acquire position data and load data from a press machine configured to move a die assembly including a working part to work a workpiece by pressing the working part onto the workpiece, the position data being related to a position of the die assembly, the load data being related to a load applied to the die assembly; and
determine a state of the working part based on the acquired position data and the acquired load data.

8. The determination method according to claim 7, wherein
the computer is caused to:
extract a load applied to the die assembly when the die assembly is at a prescribed position based on the position data and the load data; and
determine the state of the working part by comparing the extracted load to a first threshold, the first threshold being prescribed.

9. The determination method according to claim 8, further comprising causing the computer to:
refer to reference data indicating a relationship between the load applied to the die assembly and the position of the die assembly, the relationship being preregistered; and
correct the first threshold or the prescribed position by using the reference data.

10. The determination method according to claim 9, wherein
the computer is caused to:
extract a first position when the die assembly is in a prescribed state based on the reference data;
extract a second position when the die assembly is in the prescribed state based on the position data; and
correct the first threshold or the prescribed position by using a difference between the first position and the second position.

11. The determination method according to claim 8, wherein
the computer is caused to:
determine that the working part is in a first state when the extracted load is not less than the first threshold; and
determine that the working part is in a second state and output a first alert when the extracted load is less than the first threshold.

12. The determination method according to claim 11, wherein
the computer is configured to determine that the working part is in a third state and output a second alert when the extracted load is less than a second threshold, the second threshold being less than the first threshold, the second alert being different from the first alert.
